(19) United States
(12) Patent Application Publication
(10) Pub. No.: US 2024/0068618 A1
(43) Pub. Date: Feb. 29, 2024

(54) HIGH-PRESSURE TANK AND MANUFACTURING METHOD OF HIGH-PRESSURE TANK

(71) Applicant: TOYOTA JIDOSHA KABUSHIKI KAISHA, Toyota-shi (JP)

(72) Inventors: Yuki FUJIE, Toyota-shi (JP); Naoki UEDA, Nagoya-shi (JP); Akiyoshi FURUZAWA, Toyota-shi (JP)

(73) Assignee: TOYOTA JIDOSHA KABUSHIKI KAISHA, Toyota-shi (JP)

(21) Appl. No.: 18/340,015

(22) Filed: Jun. 22, 2023

(30) Foreign Application Priority Data
Aug. 25, 2022 (JP) 2022-134086

(51) Int. Cl. F17C 1/06

(52) U.S. Cl. CPC F17C 1/06; F17C 2201/0109; F17C 2203/0604; F17C 2203/0621; F17C 2203/066; F17C 2203/0673; F17C 2209/2154; F17C 2221/012; F17C 2260/012; F17C 2270/0168; F17C 2270/0184

(57) ABSTRACT

In the fiber bundle arranged in the innermost layer so as to be in contact with the liner, the end portions in the width direction of the adjacent fiber bundles are wound so as to overlap by 14% or more.

### CROSS-REFERENCE TO RELATED APPLICATION

This application claims priority to Japanese Patent Application No. 2022-134086 filed on Aug. 25, 2022, incorporated herein by reference in its entirety.

### BACKGROUND

### 1. Technical Field

The present disclosure relates to a high-pressure tank including a layer on which a fiber bundle impregnated with a resin is wound.

### 2. Description of Related Art

A high-pressure tank used in a fuel cell electric vehicle or the like includes a liner that forms an inner space of the high-pressure tank, and a fiber bundle impregnated with a resin is wound around an outer periphery of the liner to form a reinforcing layer. Thus, a high strength degree is established.

Japanese Unexamined Patent Application Publication No. 2010-265931 (JP 2010-265931 A) describes forming a reinforcing layer from hoop winding and helical winding in a manufacturing method of a tank.

Japanese Unexamined Patent Application Publication No. 2010-253789 (JP 2010-253789 A) describes that, in a high-pressure tank, when a fiber bundle spreads out by hoop winding or helical winding, the fiber bundle accidentally overlaps with an adjacent fiber.

### SUMMARY

In a conventional high-pressure tank, there is a case where a liner is deformed, and in particular, a deformation is notable due to a change in a liner material or a reduction in a thickness due to a reduction in weight.

The present disclosure has been made in view of these circumstances, and an object thereof is to provide a high-pressure tank capable of suppressing deformation of a liner. In addition, a manufacturing method of a high-pressure tank for this purpose is provided.

The inventors have embodied a means for solving the problem by obtaining knowledge that a difference in force occurs between a width direction center portion and an end portion of the fiber bundle disposed closest to a liner, and the liner deforms due to this difference.

The present application discloses a high-pressure tank in which a band-shaped fiber bundle is wound around a liner so as to constitute a plurality of layers, in which in the fiber bundle arranged in an innermost layer so as to be in contact with the liner, end portions of adjacent fiber bundles in a width direction are wound so as to overlap by 14% or more.

The fiber bundle of the innermost layer may be a low angle helical winding. Further, the liner may be formed of a resin.

The present application discloses a manufacturing method of a high-pressure tank, the manufacturing method including a step of winding a band-shaped fiber bundle on a liner so as to form a plurality of layers, in which when the fiber bundle disposed in an innermost layer so as to be in contact with the liner is wound, end portions of adjacent fiber bundles in a width direction are wound so as to overlap by 14% or more.

The fiber bundle of the innermost layer may be a low angle helical winding. Further, the liner may be formed of a resin.

According to the present disclosure, it is possible to suppress a difference in a force generated in a fiber bundle due to a part of adjacent fiber bundles overlapping, and it is possible to suppress a liner from deforming.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A shows a schematic view of a high-pressure tank;

FIG. 1B is a schematic cross-sectional view of a high-pressure tank;

FIG. 2 is a diagram illustrating an embodiment of a winding method of a fiber bundle in a high-pressure tank;

FIG. 3 is a diagram illustrating an arrangement mode of fiber bundles of the innermost layer;

FIG. 4 is a diagram for explaining a case where there is no overlapping portion in adjacent fiber bundles;

FIG. 5A is a schematic of a strain profile and a liner profile according to an embodiment;

FIG. 5B is a figure showing the shape of a liner and the corrugation of strain in a comparative example;

FIG. 6 is a graph showing the result of the overlap ratio and the strain amplitude.

### DETAILED DESCRIPTION OF EMBODIMENTS

### 1. Structure of the High-Pressure Tank

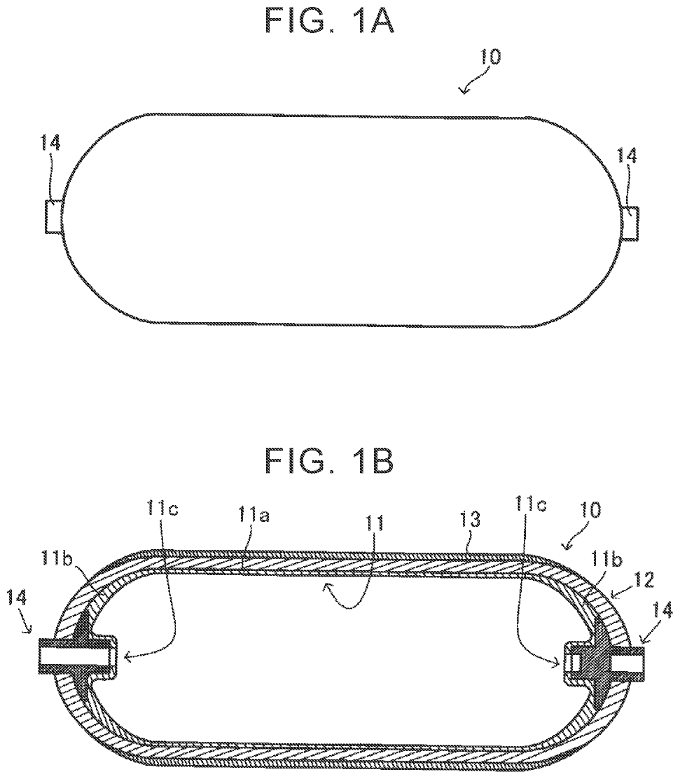

FIG. 1A schematically shows an external view of a high-pressure tank 10 according to one embodiment of the present. The cross-section along the axial line of the high-pressure tank 10 is schematically shown in FIG. 1B. As can be seen from these figures, in the present embodiment, the high-pressure tank 10 includes a liner 11, a reinforcing layer 12, a protective layer 13, and a base 14. Each configuration will be described below.

### 1.1. Liner

The liner 11 is a hollow member that partitions the internal space of the high-pressure tank 10, and is cylindrical in this embodiment. In the liner 11, the opening at both ends of the body portion 11a having a substantially constant diameter is narrowed by the dome-shaped side end portion 11b. A base 14 is arranged in the narrowed opening 11c. The liner 11 may be made of a material capable of holding the material contained in the internal space (e.g., hydrogen) without leaking. Known materials can be used. Specifically, it is made of, for example, a nylon resin, a polyethylene-based synthetic resin, or a metal such as stainless steel or aluminum.

The thickness of the liner 11 is not particularly limited, but is preferably 3.0 mm from 0.5 mm. Among them, from the viewpoint of weight reduction of the high-pressure tank, the material constituting the liner is preferably a synthetic resin. The thickness thereof is preferably 2.0 mm or less in the body portion. In a high-pressure tank including such a lightweight liner, deformation of the liner tends to be remarkably manifested in the related art, but according to the high-pressure tank of the present disclosure, the deformation is suppressed to be small.

### 1.2. Reinforcing Layer

In the reinforcing layer 12, fibers are laminated over a plurality of layers, and the fibers are impregnated with a cured resin. The fiber layer is formed by winding a fiber bundle 12a around the outer periphery of the liner 11 over a plurality of layers up to a predetermined thickness. Since the thickness of the reinforcing layers 12 and the number of turns of the fiber bundle are determined by the required strength, the thickness is not particularly limited, but is about 30 mm from 10 mm.

### Fiber Bundle

For example, carbon fibers are used for the fiber bundle 12a of the reinforcing layers 12, and the fiber bundle has a band shape having a predetermined cross-sectional shape (for example, a rectangular cross section) as a bundle of carbon fibers. Although not particularly limited, the cross-sectional shapes may be rectangles having 6 mm to 20 mm widths and 0.1 mm to 5 mm thicknesses. The amount of the carbon fiber contained in the fiber bundle is not particularly limited, but may be, for example, about 36000 carbon fibers.

### Impregnated Resin

The resin impregnated and cured in the fiber (fiber bundle) in the reinforcing layer 12 is not particularly limited as long as it can increase the strength of the fiber. Examples thereof include thermosetting resins, which are cured by heat, and specific examples thereof include an amine-based or anhydride-based curing accelerator, an epoxy resin containing a rubber-based reinforcing agent, and an unsaturated polyester resin. In addition, a resin composition containing an epoxy resin as a main agent and cured by mixing a curing agent therewith can also be mentioned. According to this configuration, the resin composition, which is a mixture of the main agent and the curing agent, reaches and penetrates the fiber layer during the period from the mixing to the curing, and thereby the resin composition is automatically cured.

### Winding Mode of the Fiber Bundle

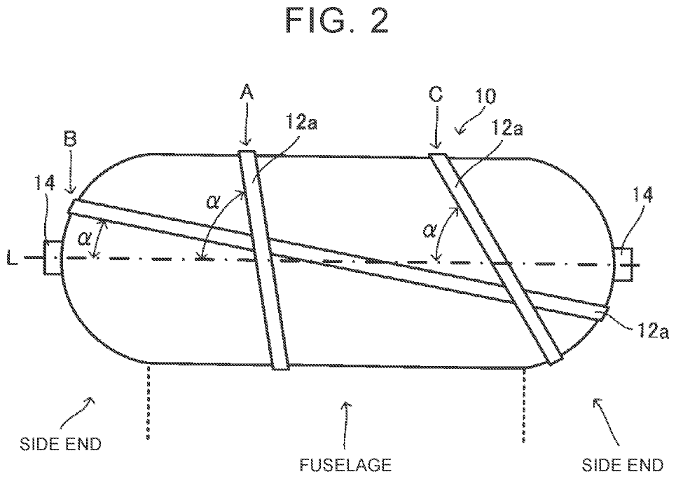

Next, the manner in which the fiber bundle 12a is wound around the liner 11 in the high-pressure tank 10 will be described. FIG. 2 shows a diagram for explanation. FIG. 2 shows a portion of the wound fiber bundle 12a for clarity. As described above, in the reinforcing layers 12, the fiber bundle 12a is wound around the outer periphery of the liner 11.

There are hoop windings and helical windings in the winding mode of the fiber bundle 12a, and the helical windings further include low angle helical windings and high angle helical windings.

As shown in A in FIG. 2, the hoop winding is mainly applied to the body portion, and the inclination angle α with respect to the axis L of the high-pressure tank 10 is 80° or more and 90° or less. In the hoop winding, the portion is wound to exert a force that opposes the force that the liner 11 tends to expand radially outward by the gas pressure.

On the other hand, the helical winding is a winding method mainly intended to wind the side end portion inward in the axial direction of the high-pressure tank, by winding the fiber bundle 12a entirely to the liner 11 so as to be hooked to the side end portion, to improve the strength of the side end portion. The low angle helical winding is applied by winding so as to pass two side ends mainly on the opposite side as shown in B in FIG. 2, and the inclination angle α is wound at 5° or more and 30° or less with respect to the axis L of the high-pressure tank 10. The high-angle helical winding is applied by being wound mainly so as to pass the body portion and the side end portion as shown in C in FIG. 2, and the inclination angle α is wound at 70° or more and less than 80° with respect to the axis L of the high-pressure tank 10.

In this embodiment, one layer of low-angle helical winding is wound in contact with the outer peripheral surface of the liner 11 (that is, the innermost layer of the reinforcing layer 12), and the high-angle helical winding and the hoop winding are repeated on the outside. However, a low-angle helical winding may also be applied as appropriate.

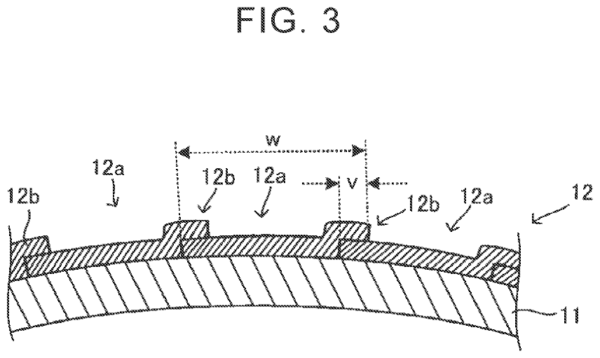

Further, in the present embodiment, among the wound fiber bundles 12a, in the fiber bundle 12a of the low-angle helical winding which is in contact with the outer peripheral surface of the liner 11 as the innermost layer, in the width direction of the fiber bundle 12a (the direction perpendicular to the direction in which the band-shaped fiber bundle 12a extends), the adjacent fiber bundle 12a portion of the width direction end portion is wound so as to overlap in the thickness direction. FIG. 3 shows a conceptual diagram for explanation. FIG. 3 shows a portion of the cross-section of the low-angle helically wound fiber bundle 12a and liner 11 disposed in the innermost layer, the cross-section being a cross-section perpendicular to the direction in which the fiber bundle 12a extends.

As can be seen from FIG. 3, the fiber bundle 12a in the portion has an overlapping portion 12b in which the widthwise end portions overlap each other in the thickness direction. Here, where w is the width of the fiber bundle 12a and v is the amount in which the adjacent fiber bundle 12a overlap (the size in the direction parallel to the width direction), the overlap ratio represented by v/w×100% is 14% or more in the mean of all the fiber bundle 12a which are the low-angle helical windings in contact with the outer peripheral surface of the liner 11 in the innermost layer included in the high-pressure tank 10. It is preferable that the overlap rate is 14% or more in all the overlapping portion 12b, but the overlap rate is not necessarily 14% or more in all the overlapping portion 12b. As described above, the average value may be used.

By providing such an overlapping portion, deformation of the liner 11 can be suppressed more reliably. If the overlap ratio is less than 14%, there is an increased possibility that the deformation of the liner is not sufficiently suppressed. The upper limit of the overlap rate is not particularly limited, and if the overlap rate is increased, the deformation of the liner 11 can be suppressed, but 12a of fiber bundles to be used increases by increasing the overlap portion. From this viewpoint, the overlap ratio is preferably 50% or less. It is considered that such deformation of the liner occurs at the time of manufacturing the high-pressure tank, and the deformation generated here remains in the high-pressure tank, which is the final product. The manufacturing method is not particularly limited, but an example thereof will be described later.

### 1.3. Protective Layer

The protective layer 13 is a layer disposed on the outer periphery of the reinforcing layer 12 as necessary, and when provided, for example, glass fibers are wound, and the resin is impregnated in the layer. The impregnated resin can be considered similar to the reinforcing layer 12. Thus, impact resistance can be imparted to the high-pressure tank 10.

The thickness of the protective layers 13 is not particularly limited, but may be about 5 mm from 1.0 mm.

### 1.4. Base

The base 14 is a member attached to each of the two opening 11c of the liner 11. One of the bases 14 functions as an opening for communicating the inside and outside of the high-pressure tank 10, and also functions as an attachment portion for attaching a pipe or a valve to the high-pressure tank 10. The base 14 also functions as an attachment portion for attaching the liner 11 to the multi-yarn filament winding device when forming the reinforcing layer 12.

### 2. Manufacturing Method

The production of the high-pressure tank 10 described above can be carried out by known methods other than forming the overlapping portion 12b. For example, a method of manufacturing a high-pressure tank includes a step of forming a layer by a fiber bundle, a step of installing and degassing a mold, a step of supplying and stopping a resin composition, and a step of releasing a mold.

Each step will be described below.

### 2.1. Step of Forming a Layer by Fiber Bundles

In the step of forming the layer by the fiber bundle, the fiber bundle 12a is wound around the outer periphery of the liner 11. That is, in this step, the pressure inside the liner 11 is increased, and the first layer of the low-angle helical winding in contact with the outer surface of the liner 11 and the plurality of layers wound on the outside of the first layer are wound with the high-angle helical winding or hoop winding to form a layer.

At this time, the first layer by the low-angle helical winding is wound so that an overlapping portion of 14% or more occurs between the widthwise end portions of the fiber bundle 12a arranged at the adjacent positions as described above.

In this case, glass fibers for the protective layer 13 may be wound as necessary.

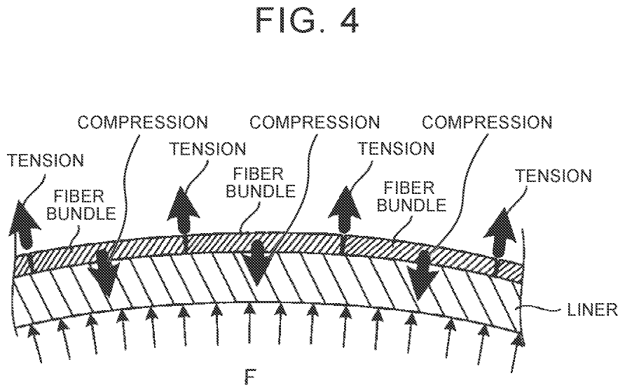

As shown in FIG. 4, the inventor has found that when the fiber bundle is wound, when the force applied to the fiber bundle by the force F from the inside of the pressurized liner is viewed, there is no overlapping portion in the adjacent fiber bundle, or when the degree of the size of the overlapping portion is insufficient, a compressive force for pressing the liner at the center in the width direction of the fiber bundle is generated, while a tensile force acting on the opposite side to this occurs at the end in the width direction of the fiber bundle, and a large distribution is generated in the force for pressing the liner in the width direction of the fiber bundle (the force applied in the direction of suppressing the swelling of the liner). It is considered that the distribution of the force increases the deformation of the liner, and by providing the overlapping portion as described above, the distribution of the force can be suppressed low, and the deformation of the liner can be suppressed.

Such winding of the fiber bundle 12a is carried out in the present embodiment by a filament-winding method. For example, a plurality of bobbins on which the fiber bundle 12a is wound are wound around the fiber bundle 12a using a multi-feed filament winding device arranged so as to surround the liner 11 along the outer periphery of the liner 11. There is no particular limitation on the number of bobbins that can be installed at the same time in the multi-feed filament winding device, but for example, 48 bobbins can be installed in some cases.

### 2.2. Installation and Degassing Processes in the Mold

In the step of installation and degassing in a mold, a preform (a member in which a fiber bundle is wound on a liner) produced in the step of forming a layer by a fiber bundle is placed inside the mold, and degassing is performed by evacuating the inside of the mold. By this degassing, the resin composition to be impregnated easily permeates the fiber bundle, and the impregnation is performed more smoothly.

### 2.3. Process of Supplying and Stopping the Resin Composition

In the step of supplying and stopping the resin composition, the resin composition before curing is supplied to the layer by the fiber bundle of the preform arranged in the mold through the flow path, and the supply is stopped by supplying the necessary amount of the resin composition. Thus, the resin composition impregnates the fiber bundle.

### 2.4. Demolding Process

In the releasing step, the supplied impregnated resin composition is obtained to be cured, and the resin impregnated preform is released from the mold.

### 3. Examples

In the examples, the deformation of the liner was examined by changing the overlap ratio of the overlapping portion in the fiber bundle of the low-angle helical winding which is the innermost layer of the high-pressure tank and is in contact with the outer peripheral surface of the liner. In addition, as a comparative example, an example in which no overlapping portion was provided (an example in which the overlapping ratio was 0%) was combined and examined.

### 3.1. High-Pressure Tank for Testing

The specifications of the high-pressure tank used in the test are as follows. In this test, no protective layer is provided.

### Liner

Material: polyamide 6 (nylon 6) and polyamide 66 (nylon 66), Young's modulus 2400 MPa
Thickness at body: 2 mm
Bore diameter: 256 mm
Axial length: 1200 mm

### Fiber Bundle

Fiber: Carbon fiber
Fiber bundle size: Width 16 mm×thickness 0.3 mm
Number of turns: 45 turns or more
Overlap ratio: 14% (Example 1), 33% (Example 2), 45% (Example 3), and 0% (Comparative Example 1), where the overlap ratio is the average value of the overlap ratio of all the overlapping portions in the fiber bundle of the low-angle helical winding that becomes the innermost layer of the high-pressure tank and is in contact with the outer peripheral surface of the liner.

### Impregnated Resin

Resin: Epoxy resin

### 3.2. Test Methods and Evaluation Methods

At the time of preparation of the high-pressure tank for testing, the inside of the liner was filled with nitrogen, and the pressure inside the liner was increased to 0.7 MPa, and the fiber bundle was wound by the filament wine-dining method. The test was carried out by measuring the strain generated in the high-pressure tank for each circumferential position using a method (dispersive optical fiber sensing) of measuring the strain by winding an optical fiber around the outer periphery of the produced high-pressure tank and receiving the backscattered light through the pulsed light. Then, the waveform of the strain, which is the strain distribution along the circumferential direction, is obtained and evaluated by the magnitude of the amplitude. The amplitude of the strain is an average value of the amplitudes in the obtained waveform of the strain, and the larger the amplitude of the strain, the larger the deformation of the liner.

### 3.3. Results

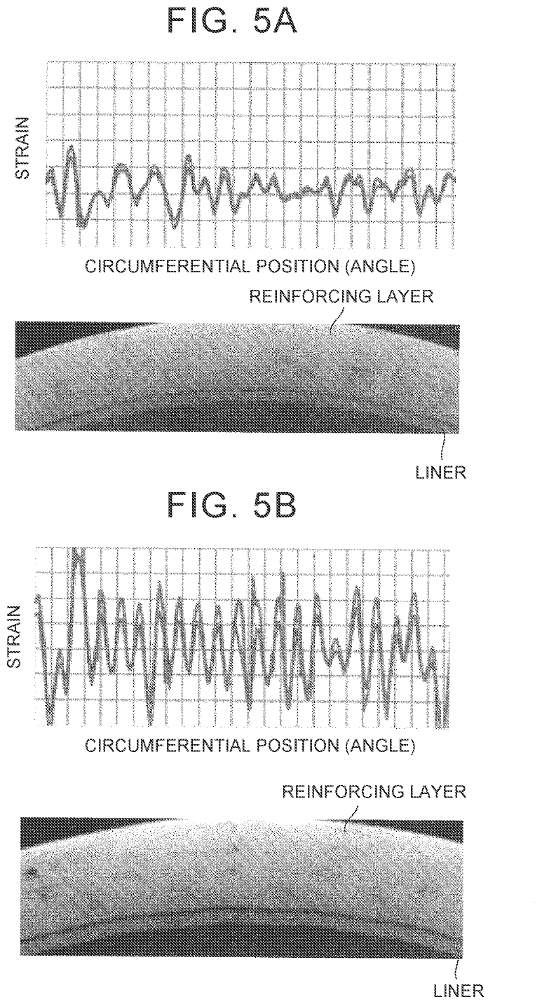

FIGS. 5A and 5B show examples of the wave forms of the strain obtained (upper graph of each figure, horizontal axis: circumferential position, vertical axis: strain) and a part of the cross section of the high-pressure tank (lower graph of each figure, CT image). FIG. 5A is an example when the overlap ratio 14%, is an example when the diagram 5B overlap ratio 0%.

As can be seen FIG. 5A from FIG. 5B, by setting the overlap rate to 14%, the amplitude of the wave form of the strain is reduced, it can be seen that the deformation of the liner is suppressed.

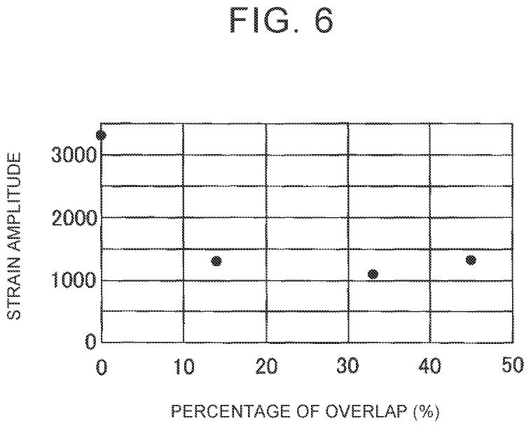

In FIG. 6, the magnitude of the strain amplitude at each overlap rate is shown in a graph. As can be seen from FIG. 6, since the overlap ratio is 14% or more, it is possible to reliably suppress the strain amplitude to be low, and it is possible to suppress the deformation of the liner.

What is claimed is:

1. A high-pressure tank in which a band-shaped fiber bundle is wound around a liner so as to constitute a plurality of layers, wherein
in the fiber bundle arranged in an innermost layer so as to be in contact with the liner, end portions of adjacent fiber bundles in a width direction are wound so as to overlap by 14% or more.

2. The high-pressure tank according to claim 1, wherein the fiber bundle of the innermost layer is a low angle helical winding.

3. The high-pressure tank according to claim 1, wherein the liner is made of a resin.

4. A manufacturing method of a high-pressure tank, the manufacturing method comprising a step of winding a band-shaped fiber bundle on a liner so as to constitute a plurality of layers, wherein
when the fiber bundle disposed in an innermost layer so as to be in contact with the liner is wound, end portions of adjacent fiber bundles in a width direction are wound so as to overlap by 14% or more.

5. The manufacturing method according to claim 4, wherein the fiber bundle of the innermost layer is wound by a low angle helical winding.

6. The manufacturing method according to claim 4, wherein the liner is made of a resin.
